(19) United States
(12) Patent Application Publication
(10) Pub. No.: US 2025/0322174 A1
(43) Pub. Date: Oct. 16, 2025

(54) CONSISTENT MULTI-TURN CONVERSATION MANAGEMENT

(71) Applicant: OPEN TEXT INC., Wilmington, DE (US)

(72) Inventors: Adam Luciano, Austin, TX (US); Vijay Mullangi, Bengaluru (IN); Arun Sharma, Bangalore (IN)

(73) Assignee: OPEN TEXT INC., Wilmington, DE (US)

(21) Appl. No.: 18/797,237

(22) Filed: Aug. 7, 2024

(30) Foreign Application Priority Data
Apr. 15, 2024 (IN) 202411030323

(51) Int. Cl. G06F 40/35

(52) U.S. Cl. CPC G06F 40/35

(57) ABSTRACT

Systems and methods are provided for more natural human-machine interactions. Artificial intelligence (AI) fails to consider the context of one question that is provided by a previous question. By preserving metadata (e.g., entities, intents, and topics and/or the question itself) for a particular question for use in a second question, which the user may not be aware of, an AI system, can more accurately select a relevant response. If the user changes the topic, a topic detection services will detect the change and exclude the metadata, which is now irrelevant, from influencing the response to the current question.

### FIELD OF THE DISCLOSURE

The invention relates generally to systems and methods for managing human-machine interactions and particularly to efficiently detecting and managing related and unrelated query topics.

### CROSS REFERENCE TO RELATED APPLICATIONS

This application claims priority to India Patent Application No. 202411030323, filed Apr. 15, 2024, the entire contents of which is incorporated herein by reference.

### FIELD OF THE DISCLOSURE

The invention relates generally to systems and methods for manage human-machine interactions and particularly to efficiently detecting and managing related and unrelated query topics.

### BACKGROUND

Early computers could respond to queries but only if the question was formulated in a specific way and the subject was a limited set of data, such as obtaining the result of a mathematical operation. Alan Turing recognized that what was easy for a human was difficult for a computer, like interactions using natural speech, and what was easy for a computer was difficult for a human, like complex calculations.

Computer science now includes artificial intelligence (AI) and AI language models, such as large language models (LLM), vector database, as well as algorithmic-determined query processing methodologies. As result, humans are more able to rely on natural language questions when interacting with a machine. Many AI-based solutions can very nearly pass an exhaustive Turing Test. However, machines are still not a perfect human analog. “Hallucinations” result when a machine produces an incorrect result.

Even with the advances in the computing sciences, problems remain.

### SUMMARY

AI systems may encounter a hallucination from a variety of issues, most of which would be readily recognized as erroneous by a human. A fault in prior art AI based systems is the evaluation of one query as the entity of a conversation (e.g., person(s), place(s), company(ies), etc.). Many AI systems require identification of a corpus of information. A user will generally get a good response provided an accurate response is obtainable solely from the corpus. If the user's query goes outside of the corpus, the results are more unpredictable and less accurate. Accordingly, prior art AI-based systems may utilize a “brute force” approach to questions presented by a user. This often forces the user to obtain a result, realize it is insufficient, and reformulate the question to include more information, something human-to-human interactions rarely need. For example, a user may ask: “Where are the best pizza restaurants in New York?” Both a machine and a human may provide a list of a top pizzerias in New York. If the user then asks a second questions, such as: “Are there any with a good museum nearby?”

A machine-based solution of the prior art would likely respond with a list of museums near the user's current location. In contrast, a human would understand that “museums nearby” is implicitly referring back to the previous question and provide an answer identifying New York museums near top rated pizzerias. The user could then restructure the question to specifically ask the machine for New York museums nearest one of the top ten pizzerias. While reformulating the question may be effective, it may require numerous back-and-forth refinements in order to discover the correct question to ask in order to obtain the desired answer. Such interactions can waste computational resources as the user, often blindly, modifies their question in the hopes of receiving the desired answer. All but the last question is erroneous, irrelevant, or unusable. Additionally, many AI-based systems use the human-machine interactions as a training input. The machine does not know that the answer, even if technically correct, was not the desired answer or even useful. If the system is not informed of the error, it may include or up-weight the erroneous/irrelevant response to become more prevalent in future interactions and further wasting computational resources.

These and other needs are addressed by the various embodiments and configurations of the present invention. The present invention can provide a number of advantages depending on the particular configuration. These and other advantages will be apparent from the disclosure of the invention(s) contained herein.

In some aspects, the techniques described herein relate to a method, including: receiving a first question from a user; providing the first question to a vector database; receiving, from the vector database, a first set of data chunks; providing the first set of data chunks and a first context, the first context including the first question, to an artificially intelligent language model; receiving, from the artificially intelligent language model, a first set of metadata and a first response; storing the first set of metadata for use with a second question; and providing the first response to the user.

In some aspects, the techniques described herein relate to a method, wherein the artificially intelligent language model includes a large language model.

In some aspects, the techniques described herein relate to a method, further including: receiving the second question from the user; determining whether the second question is a topic shift from the first question; upon determining that the second question is not a topic shift from the first question: providing the second question and the first set of metadata to the vector database; receiving, from the vector database, a second set of data chunks; providing the second set of data chunks and a second context, the second context including the second question, to the artificially intelligent language model; receiving, from the artificially intelligent language model, a second set of metadata and a second response; storing the second set of metadata for use with a third question; and providing the second response to the user.

In some aspects, the techniques described herein relate to a method, wherein determining whether the second question is a topic shift from the first question includes: obtaining a consign similarity value for a first topic of the first question and a second topic of the second question; upon determining a cosine similarity value is greater than a previously determined threshold, the second question is not a topic shift from the first question; and upon determining the cosine similarity value is not greater than the previously determined threshold, the second question is a topic shift from the first question.

In some aspects, the techniques described herein relate to a method, wherein determining whether the second question is a topic shift from the first question includes: obtaining a consign similarity value for the first question and the second question; upon determining a cosine similarity value is greater than a previously determined threshold, the second question is not a topic shift from the first question; and upon determining the cosine similarity value is not greater than the previously determined threshold, the second question is a topic shift from the first question.

In some aspects, the techniques described herein relate to a method, wherein the first set of metadata includes at least one of entities, topic, and intent, wherein the entities include at least one of an entity of the first question or an entity of the first response, and wherein the topic includes at least one of a question topic or an answer topic.

In some aspects, the techniques described herein relate to a method, further including: receiving the second question from the user; determining whether the second question is a topic shift from the first question; upon determining that the second question is a topic shift from the first question: providing the second question to the vector database; receiving, from the vector database, a second set of data chunks; providing the second set of data chunks and a second context, the second context including the second question, to the artificially intelligent language model; receiving, from the artificially intelligent language model, a second set of metadata and a second response; storing the second set of metadata for use with a third question; and providing the second response to the user.

In some aspects, the techniques described herein relate to a method, wherein the second set of metadata further includes the first question.

In some aspects, the techniques described herein relate to a method, wherein the artificially intelligent language model applies the first set of data chunks and the first context to a knowledge graph to generate the first set of metadata and the first response.

In some aspects, the techniques described herein relate to a method, further including: receiving the second question from the user; determining whether the second question is a topic shift from the first question; upon determining that the second question is not a topic shift from the first question: providing the second question and the first set of metadata to the artificially intelligent language model; receiving, from the artificially intelligent language model, a second set of metadata and a second response; storing the second set of metadata for use with a third question; and providing the second response to the user.

In some aspects, the techniques described herein relate to a system, including: an input device; an output device; and a computing device including one or more processors coupled to a computer memory including instructions; and wherein the instructions cause the one or more processors to perform: receiving a first question from the input device; providing the first question to a vector database; receiving, from the vector database, a first set of data chunks; providing the first set of data chunks and a first context, the first context including the first question, to an artificially intelligent language model; receiving, from the artificially intelligent language model, a first set of metadata and a first response; storing the first set of metadata for use with a second question; and providing the first response to the output device.

In some aspects, the techniques described herein relate to a system, further including instructions to cause the one or more processors to perform: receiving the second question from the input device; determining whether the second question is a topic shift from the first question; upon determining that the second question is not a topic shift from the first question: providing the second question and the first set of metadata to the vector database; receiving, from the vector database, a second set of data chunks; providing the second set of data chunks and a second context, the second context including the second question, to the artificially intelligent language model; receiving, from the artificially intelligent language model, a second set of metadata and a second response; storing the second set of metadata for use with a third question; and providing the second response to the output device.

In some aspects, the techniques described herein relate to a system, further including instructions to cause the one or more processors to perform: obtaining a cosine similarity value for a first topic of the first question and a second topic of the second question; upon determining the cosine similarity value is greater than a previously determined threshold, the second question is not a topic shift from the first question; and upon determining the cosine similarity value is not greater than the previously determined threshold, the second question is a topic shift from the first question.

In some aspects, the techniques described herein relate to a system, wherein the instructions to cause the one or more processors to perform determining whether the second question is a topic shift from the first question further include instructions to cause the one or more processors to perform: obtaining a cosine similarity value for the first question and the second question; upon determining the cosine similarity value is greater than a previously determined threshold, the second question is not a topic shift from the first question; and upon determining the cosine similarity value is not greater than the previously determined threshold, the second question is a topic shift from the first question.

In some aspects, the techniques described herein relate to a system, wherein the first set of metadata includes at least one of entities, topic, and intent, wherein the entities include at least one of an entity of the first question or an entity of the first response, and wherein the topic includes at least one of a question topic or an answer topic.

In some aspects, the techniques described herein relate to a system, further including instructions to cause the one or more processors to perform: receiving the second question from the input device; determining whether the second question is a topic shift from the first question; upon determining that the second question is a topic shift from the first question: providing the second question to the vector database; receiving, from the vector database, a second set of data chunks; providing the second set of data chunks and a second context, the second context including the second question, to the artificially intelligent language model; receiving, from the artificially intelligent language model, a second set of metadata and a second response; storing the second set of metadata for use with a third question; and providing the second response to the output device.

In some aspects, the techniques described herein relate to a system, wherein the second set of metadata further includes the first question.

In some aspects, the techniques described herein relate to a system, wherein the artificially intelligent language model applies the first set of data chunks and the first context to a knowledge graph to generate the first set of metadata and the first response.

In some aspects, the techniques described herein relate to a system, further including instructions to cause the one or more processors to perform: receiving the second question from the input device; determining whether the second question is a topic shift from the first question; upon determining that the second question is not a topic shift from the first question: providing the second question and the first set of metadata to the artificially intelligent language model; receiving, from the artificially intelligent language model, a second set of metadata and a second response; storing the second set of metadata for use with a third question; and providing the second response to the output device.

In some aspects, the techniques described herein relate to a non-transitory computer readable medium including instructions that, when read by a machine, cause the machine to perform: receiving a first question from a user; providing the first question to a vector database; receiving, from the vector database, a first set of data chunks; providing the first set of data chunks and a first context, the first context including the first question, to an artificially intelligent language model; receiving, from the artificially intelligent language model, a first set of metadata and a first response; storing the first set of metadata for use with a second question; and providing the first response to the user.

In some aspects, the techniques described herein relate to a non-transitory computer readable medium, further including instructions to cause the machine to perform: receiving the second question from the user; determining whether the second question is a topic shift from the first question; upon determining that the second question is not a topic shift from the first question: providing the second question and the first set of metadata to the vector database; receiving, from the vector database, a second set of data chunks; providing the second set of data chunks and a second context, the second context including the second question, to the artificially intelligent language model; receiving, from the artificially intelligent language model, a second set of metadata and a second response; storing the second set of metadata for use with a third question; and providing the second response to the user.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112 (f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIGS. 2A and 2B depict a process in accordance with embodiments of the present disclosure;

FIG. 3 depicts an encyclopedic knowledge graph accordance with embodiments of the present disclosure;

FIG. 4 depicts a common sense knowledge graph accordance with embodiments of the present disclosure;

FIG. 5 depicts a domain-specific knowledge graph accordance with embodiments of the present disclosure;

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

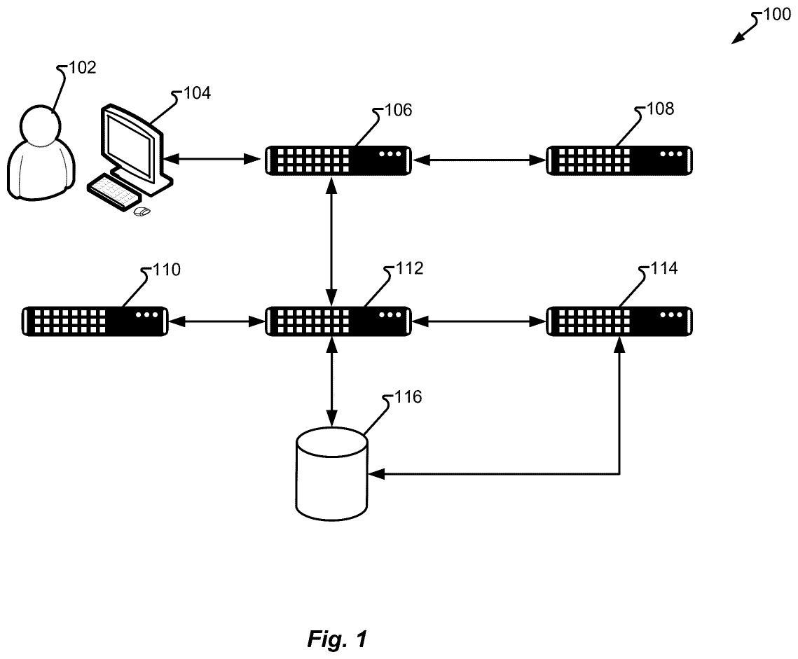

FIG. 1 depicts system 100 in accordance with embodiments of the present disclosure. System 100 illustrates components comprising computing components 104, 106, 108, 110, 112, 114, and a data storage component (e.g., data storage 116) interconnected, such as via a network. It should be appreciated that, in one embodiment, each of the illustrated components provides a single service. However, one of ordinary skill in the art will recognize that other topologies may be deployed without departing from the scope of embodiments herein. For example, any one component may be embodied as a plurality of components and/or any two or more components may be embodied as a single component. In one embodiment, the components as illustrated perform a single function, in other embodiments, one or more components may perform a plurality of functions and/or one or more functions may be performed by a plurality of components including as a service (e.g., software as a service (SaaS)).

In one embodiment, user 102 interacts with computer 104 as an interface to the remainder of system 100, such as computer 104. Computer 106 receives queries from user 102 and presents responses to the queries. The term “query” and forms thereof may be used herein interchangeably with the term “question” and forms thereof. While computer 104 is illustrated as a desktop computer, other form factors may be utilized that comprise or utilize an input component, an output component, and a network interface or other communication, such as to communicate with server 106.

In another embodiment, server 106 provides prompt engineering and user response services, server 108 provides artificially intelligent (AI) language model services, server 110 provides topic shift detection, server 112 provides retrieval services, server 114 provides summarization services, and data storage 116 provides a vector database. In another embodiment, server 108 provides the AI language model services further comprising large language model (LLM) services. In yet another embodiment, server 108 provides the AI language model services further comprising a knowledge graph service. In still another embodiment, server 108 provides AI language model services further comprising a coordinated service of both an LLM and knowledge graph.

In another embodiment, server 108 receives requests, such as LLM service requests from server 106 and provides a response thereto. Server 108 retrieves LLM context (e.g., data chunks, summarized content, and/or previous queries/responses from server 112. Server 110 determines if a topic shift did or did not occur between two sequential questions. As a further option server 110 may determine if a topic is common to a previous question asked with a different topic therebetween. In another embodiment, server 112 requests summarization from server 114 and receives therefrom a summary of the content.

In another embodiment, server 112 retrieves data chunks (which may be referred to herein as a “chunk” or plurality of “chunks”). Server 114 summarizes contents for one or a plurality of interactions (i.e., query-response) such as to maintain, and modify, a summary of the topics over two or more interactions.

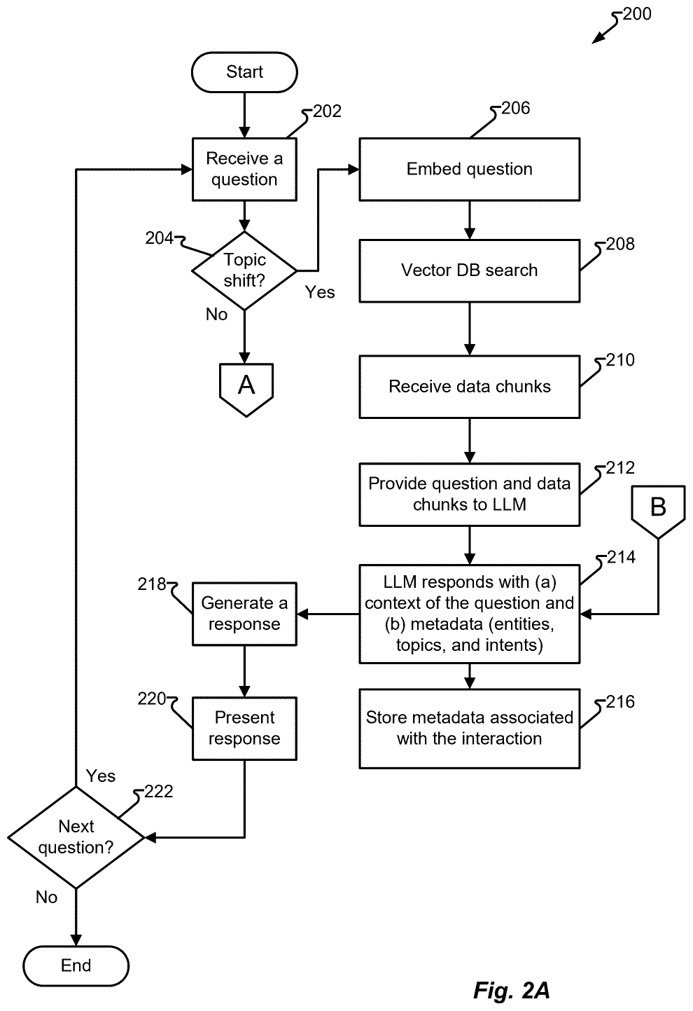

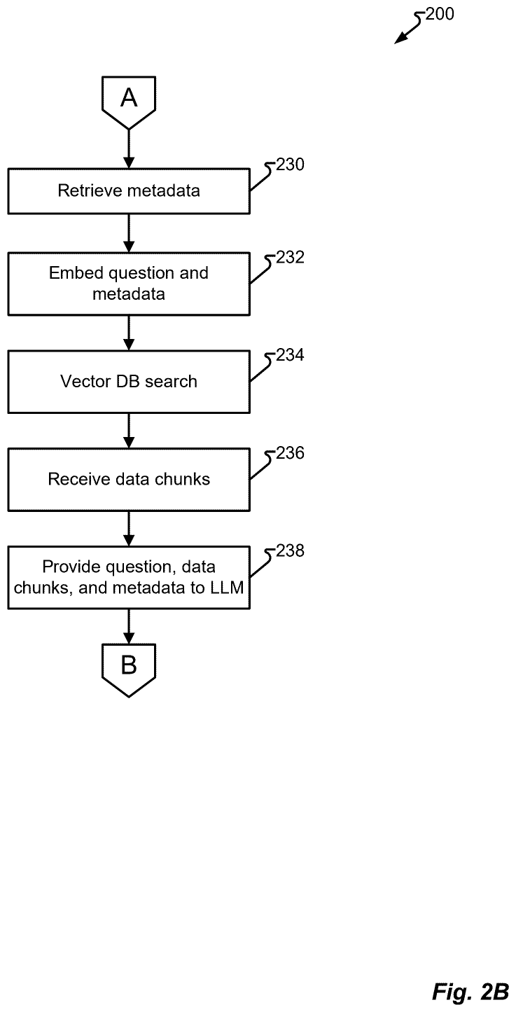

FIGS. 2A and 2B depict process 200 in accordance with embodiments of the present disclosure. In one embodiment, process 200 is embodied as machine-readable instructions maintained in a non-transitory memory that when read by a machine, such a processor of a server, cause the machine to execute the instructions and thereby execute process 200. The processor of the server may include, but is not limited to, at least one processor of computer 104, server 106, server 108, server 110, server 112, server 114, or combinations thereof.

In one embodiment, process 200 begins and, in step 202 a question is received from a user, such as user 102 utilizing computer 104. Test 204 determines if there is a topic change from the immediately preceding question. If question 202 is the first question received for a particular interaction session with the user then the preceding question may be considered as “null” and, therefore, the current question represents a new topic and test 204 is determined in the affirmative. If the question received in step 202 is a subsequent question then the immediately preceding question evaluated by test 204 to determine whether a topic change occurred between the current question asked in step 202 and a preceding question asked in a previously iteration of step 202. If test 204 is determined in the negative processing continues, via off-page connector “A”, to step 230 (see FIG. 2B).

Step 206 prepares the query received in step 202, such as to embed the query into a format acceptable to the vector DB, such as a vector database embodied by data storage 116, and submits the query or prepared query to the vector DB in step 208. The vector DB returns data chunks in step 210. The data chunks are then provided to the LLM in step 212 along with the question in order to provide context for the data chunks. The LLM responds in step 214 with a context of the question, which is then formatted into a response in step 218 and presented to the user in step 220. Step 214 also receives metadata from the LLM, such as entities, topics, and intents. The metadata is stored in step 216.

After presenting the response in step 220, test 222 determines if there is a next question. If test 222 is determined in the negative, process 200 may end. If test 222 is determined in the affirmative, processing continues and loops back to step 202.

In a second (or subsequent) iteration, test 204 determines if the previous question, received in the previous iteration of step 202, and the current question, received in the current iteration of step 202, represent a change in topic. A change in topic may be determined by performing a cosine similarity test on the two questions and, based on the value returned therefrom, test 204 is determined in the affirmative or negative. As described above, if test 204 is determined in the affirmative, processing continues to step 206. Optionally, data captured in response to a previous question, such as by step 216, may be discarded.

If test 204 is determined in the negative, the processing continues to step 230 (via off-page connector “A” to FIG. 2B). Step 230 retrieves metadata from the previous question, such as the metadata stored by step 216. Step 230 may retrieve all the metadata (e.g., intention, topics, intents and/or the previous question itself) or a portion thereof (e.g., only the intentions).

Step 232 then embeds the question and retrieve metadata into a query and, in step 234, submits the query to the vector DB for searching. The returned data chunks received in step 236 are then the result of the search utilizing the question, within the context of the metadata, without requiring the user to specifically include the context. The retrieved data chunks, user question, and metadata are then provided to the LLM in step 238. Step 214, via off-page connector “B”, then receives a response from the LLM in the form of the context of the question, which is further processed in step s 218 and 220 into a response for presentation to the user's question, and new metadata, which is then stored in step 216. Processing may continue until step 222 determines there are no next questions.

Process 200, in part, determines whether a topic is the same or different from the immediately preceding question and responds accordingly. In another embodiment, process 200 may consider if a question is the same to any one of a number of previous questions with an interceding question of a different topic. For example, questions may be stored independently or as a component of another step, such as step 216 which may store metadata for each response received from the LLM in step 214. Step 204 may then perform an analysis (e.g., cosine similarity) on the current question received in step 202 to each of the stored questions. If the fourth prior question is similar to a current question received in a current iteration of step 202 the, test 204 is determined in the negative with respect to the fourth prior question. Step 230 then retrieve the metadata associated with the fourth prior question and processing continues accordingly.

In another embodiment, step 214 returns trajectories of the response (e.g., various “directions” a response may go), such as may occur if a question has more than one reasonable responses. For example, “What should I do during my trip to New York?” A response may identify a number of popular activities for tourists. Further analysis, such as a cosign similarity, may reveal great differences in those activities segmented by interests (e.g., Broadway shows, restaurants, museums, historic sites, etc.). As a result, the user may be prompted to refine their question via selection of one of the trajectories. The resulting metadata saved in step 216 and response processing in steps 218 and 220.

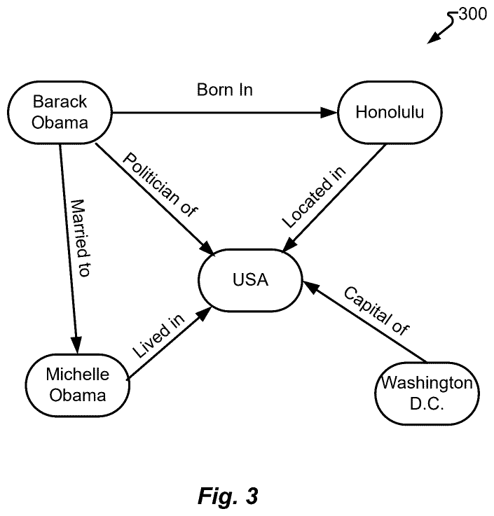

FIG. 3 depicts encyclopedic knowledge graph 300 accordance with embodiments of the present disclosure. In one embodiment, utilizes encyclopedic knowledge graph 300 to obtain a context for a question and/or metadata, such as to supplement or replace the LLM in step 214 (see FIG. 2).

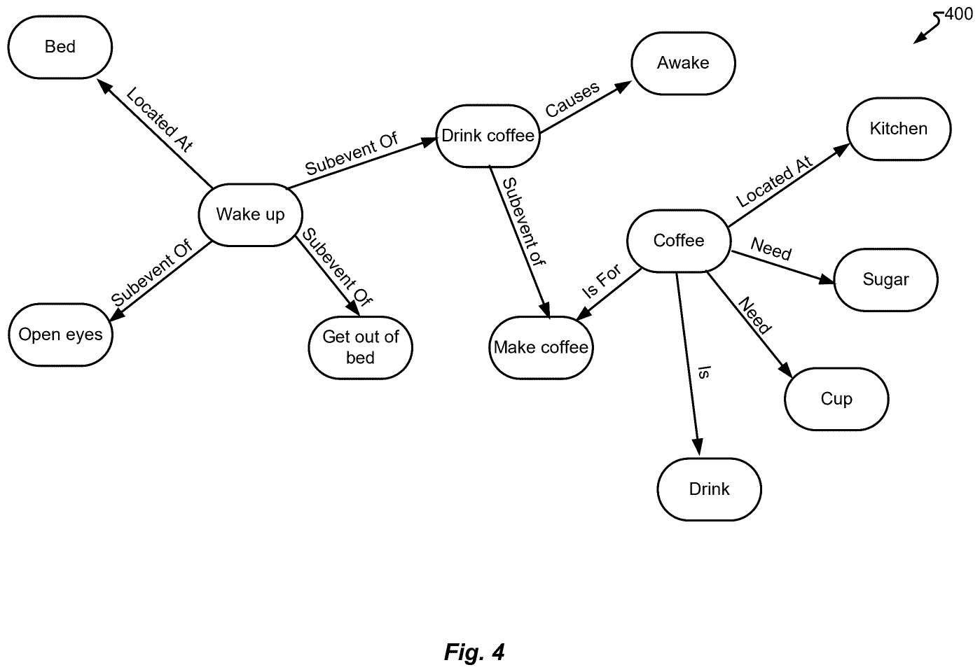

FIG. 4 depicts common sense knowledge graph 400 accordance with embodiments of the present disclosure. In one embodiment, utilizes common sense knowledge graph 400 to obtain a context for a question and/or metadata, such as to supplement or replace the LLM in step 214 (see FIG. 2)

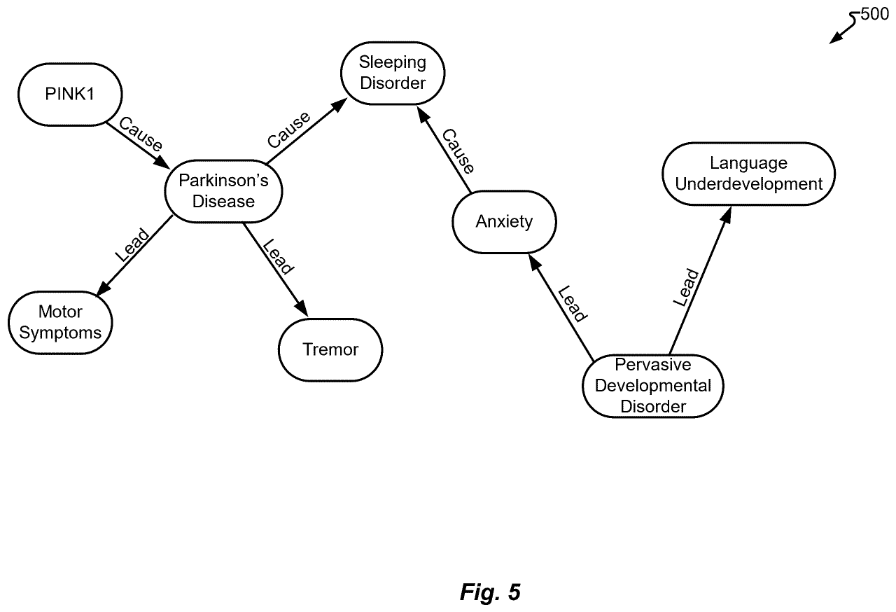

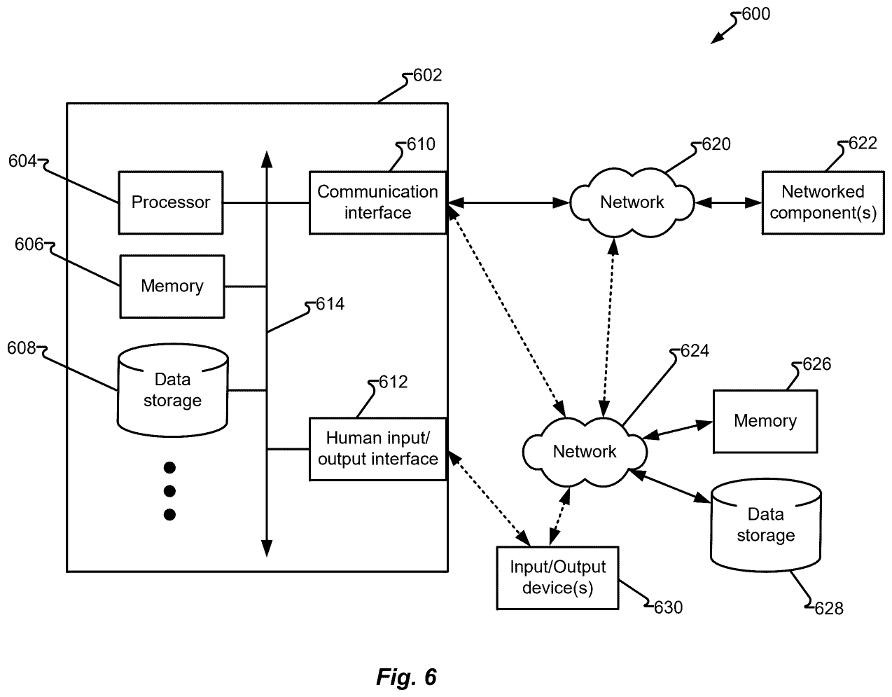

FIG. 5 depicts domain-specific knowledge 500 graph accordance with embodiments of the present disclosure. In one embodiment, utilizes domain-specific knowledge 500 to obtain a context for a question and/or metadata, such as to supplement or replace the LLM in step 214 (see FIG. 2)

FIG. 6 depicts device 602 in system 600 in accordance with embodiments of the present disclosure. In one embodiment, computer 104, server 106, server 108, server 110, server 112, and/or server 114 may be embodied, in whole or in part, as device 602 comprising various components and connections to other components and/or systems. The components are variously embodied and may comprise processor 604. The term “processor,” as used herein, refers exclusively to electronic hardware components comprising electrical circuitry with connections (e.g., pin-outs) to convey encoded electrical signals to and from the electrical circuitry. Processor 604 may comprise programmable logic functionality, such as determined, at least in part, from accessing machine-readable instructions maintained in a non-transitory data storage, which may be embodied as circuitry, on-chip read-only memory, computer memory 606, data storage 608, etc., that cause the processor 604 to perform the steps of the instructions. Processor 604 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 614, executes instructions, and outputs data, again such as via bus 614. In other embodiments, processor 604 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 604 is a non-transitory computing device (e.g., electronic machine comprising circuitry and connections to communicate with other components and devices). Processor 604 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 604). Processor 604 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 604, device 602 may utilize computer memory 606 and/or data storage 608 for the storage of accessible data, such as instructions, values, etc. which may further comprise embodiments of data storage 116 (see FIG. 1). Communication interface 610 facilitates communication with components, such as processor 604 via bus 614 with components not accessible via bus 614 and may be embodied as a network interface (e.g., ethernet card, wireless networking components, USB port, etc.). Communication interface 610 may be embodied as a network port, card, cable, or other configured hardware device. Additionally or alternatively, human input/output interface 612 connects to one or more interface components to receive and/or present information (e.g., instructions, data, values, etc.) to and/or from a human and/or electronic device. Examples of input/output devices 630 that may be connected to input/output interface include, but are not limited to, keyboard, mouse, trackball, printers, displays, sensor, switch, relay, speaker, microphone, still and/or video camera, etc. In another embodiment, communication interface 610 may comprise, or be comprised by, human input/output interface 612. Communication interface 610 may be configured to communicate directly with a networked component or configured to utilize one or more networks, such as network 620 and/or network 624.

Network 620 may be a wired network (e.g., Ethernet), wireless (e.g., WiFi, Bluetooth, cellular, etc.) network, or combination thereof and enable device 602 to communicate with networked component(s) 622. In other embodiments, network 620 may be embodied, in whole or in part, as a telephony network (e.g., public switched telephone network (PSTN), private branch exchange (PBX), cellular telephony network, etc.).

Additionally or alternatively, one or more other networks may be utilized. For example, network 624 may represent a second network, which may facilitate communication with components utilized by device 602. For example, network 624 may be an internal network to a business entity or other organization, whereby components are trusted (or at least more so) than networked components 622, which may be connected to network 620 comprising a public network (e.g., Internet) that may not be as trusted.

Components attached to network 624 may include computer memory 626, data storage 628, input/output device(s) 630, and/or other components that may be accessible to processor 604. For example, computer memory 626 and/or data storage 628 may supplement or supplant computer memory 606 and/or data storage 608 entirely or for a particular task or purpose. As another example, computer memory 626 and/or data storage 628 may be an external data repository (e.g., server farm, array, “cloud,” etc.) and enable device 602, and/or other devices, to access data thereon. Similarly, input/output device(s) 630 may be accessed by processor 604 via human input/output interface 612 and/or via communication interface 610 either directly, via network 624, via network 620 alone (not shown), or via networks 624 and 620. Each of computer memory 606, data storage 608, computer memory 626, data storage 628 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 630 may be a router, a switch, a port, or other communication component such that a particular output of processor 604 enables (or disables) input/output device 630, which may be associated with network 620 and/or network 624, to allow (or disallow) communications between two or more nodes on network 620 and/or network 624. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
receiving a first question from a user;
providing the first question to a vector database;
receiving, from the vector database, a first set of data chunks;
providing the first set of data chunks and a first context, the first context comprising the first question, to an artificially intelligent language model;
receiving, from the artificially intelligent language model, a first set of metadata and a first response;
storing the first set of metadata for use with a second question; and
providing the first response to the user.

2. The method of claim 1, wherein the artificially intelligent language model comprises a large language model.

3. The method of claim 1, further comprising:
receiving the second question from the user;
determining whether the second question is a topic shift from the first question;
upon determining that the second question is not a topic shift from the first question:
providing the second question and the first set of metadata to the vector database;
receiving, from the vector database, a second set of data chunks;
providing the second set of data chunks and a second context, the second context comprising the second question, to the artificially intelligent language model;
receiving, from the artificially intelligent language model, a second set of metadata and a second response;
storing the second set of metadata for use with a third question; and
providing the second response to the user.

4. The method of claim 3, wherein determining whether the second question is a topic shift from the first question comprises:
obtaining a consign similarity value for a first topic of the first question and a second topic of the second question;
upon determining a cosine similarity value is greater than a previously determined threshold, the second question is not a topic shift from the first question; and
upon determining the cosine similarity value is not greater than the previously determined threshold, the second question is a topic shift from the first question.

5. The method of claim 3, wherein determining whether the second question is a topic shift from the first question comprises:
obtaining a consign similarity value for the first question and the second question;
upon determining a cosine similarity value is greater than a previously determined threshold, the second question is not a topic shift from the first question; and
upon determining the cosine similarity value is not greater than the previously determined threshold, the second question is a topic shift from the first question.

6. The method of claim 1, wherein the first set of metadata comprises at least one of entities, topic, and intent, wherein the entities comprise at least one of an entity of the first question or an entity of the first response, and wherein the topic comprises at least one of a question topic or an answer topic.

7. The method of claim 1, further comprising:
receiving the second question from the user;
determining whether the second question is a topic shift from the first question;
upon determining that the second question is a topic shift from the first question:
providing the second question to the vector database;
receiving, from the vector database, a second set of data chunks;
providing the second set of data chunks and a second context, the second context comprising the second question, to the artificially intelligent language model;
receiving, from the artificially intelligent language model, a second set of metadata and a second response;
storing the second set of metadata for use with a third question; and
providing the second response to the user.

8. The method of claim 7, wherein the second set of metadata further comprises the first question.

9. The method of claim 1, wherein the artificially intelligent language model applies the first set of data chunks and the first context to a knowledge graph to generate the first set of metadata and the first response.

10. The method of claim 1, further comprising:
receiving the second question from the user;
determining whether the second question is a topic shift from the first question;
upon determining that the second question is not a topic shift from the first question:
providing the second question and the first set of metadata to the artificially intelligent language model;
receiving, from the artificially intelligent language model, a second set of metadata and a second response;
storing the second set of metadata for use with a third question; and
providing the second response to the user.

11. A system, comprising:
an input device;
an output device; and
a computing device comprising one or more processors coupled to a computer memory comprising instructions; and
wherein the instructions cause the one or more processors to perform:
receiving a first question from the input device;
providing the first question to a vector database;
receiving, from the vector database, a first set of data chunks;
providing the first set of data chunks and a first context, the first context comprising the first question, to an artificially intelligent language model;
receiving, from the artificially intelligent language model, a first set of metadata and a first response;
storing the first set of metadata for use with a second question; and
providing the first response to the output device.

12. The system of claim 11, further comprising instructions to cause the one or more processors to perform:
receiving the second question from the input device;
determining whether the second question is a topic shift from the first question;
upon determining that the second question is not a topic shift from the first question:
providing the second question and the first set of metadata to the vector database;
receiving, from the vector database, a second set of data chunks;
providing the second set of data chunks and a second context, the second context comprising the second question, to the artificially intelligent language model;
receiving, from the artificially intelligent language model, a second set of metadata and a second response;
storing the second set of metadata for use with a third question; and
providing the second response to the output device.

13. The system of claim 12, further comprising instructions to cause the one or more processors to perform:
obtaining a cosine similarity value for a first topic of the first question and a second topic of the second question;
upon determining the cosine similarity value is greater than a previously determined threshold, the second question is not a topic shift from the first question; and
upon determining the cosine similarity value is not greater than the previously determined threshold, the second question is a topic shift from the first question.

14. The system of claim 12, wherein the instructions to cause the one or more processors to perform determining whether the second question is a topic shift from the first question further comprise instructions to cause the one or more processors to perform:
obtaining a cosine similarity value for the first question and the second question;
upon determining the cosine similarity value is greater than a previously determined threshold, the second question is not a topic shift from the first question; and
upon determining the cosine similarity value is not greater than the previously determined threshold, the second question is a topic shift from the first question.

15. The system of claim 11, wherein the first set of metadata comprises at least one of entities, topic, and intent, wherein the entities comprise at least one of an entity of the first question or an entity of the first response, and wherein the topic comprises at least one of a question topic or an answer topic.

16. The system of claim 11, further comprising instructions to cause the one or more processors to perform:
receiving the second question from the input device;
determining whether the second question is a topic shift from the first question;
upon determining that the second question is a topic shift from the first question:
providing the second question to the vector database;
receiving, from the vector database, a second set of data chunks;
providing the second set of data chunks and a second context, the second context comprising the second question, to the artificially intelligent language model;
receiving, from the artificially intelligent language model, a second set of metadata and a second response;
storing the second set of metadata for use with a third question; and
providing the second response to the output device.

17. The system of claim 16, wherein the second set of metadata further comprises the first question.

18. The system of claim 11, wherein the artificially intelligent language model applies the first set of data chunks and the first context to a knowledge graph to generate the first set of metadata and the first response.

19. The system of claim 11, further comprising instructions to cause the one or more processors to perform:
receiving the second question from the input device;
determining whether the second question is a topic shift from the first question;
upon determining that the second question is not a topic shift from the first question:
providing the second question and the first set of metadata to the artificially intelligent language model;
receiving, from the artificially intelligent language model, a second set of metadata and a second response;
storing the second set of metadata for use with a third question; and
providing the second response to the output device.

20. A non-transitory computer readable medium comprising instructions that, when read by a machine, cause the machine to perform:
receiving a first question from a user;
providing the first question to a vector database;
receiving, from the vector database, a first set of data chunks;
providing the first set of data chunks and a first context, the first context comprising the first question, to an artificially intelligent language model;
receiving, from the artificially intelligent language model, a first set of metadata and a first response;
storing the first set of metadata for use with a second question; and
providing the first response to the user.

21. The non-transitory computer readable medium of claim 20, further comprising instructions to cause the machine to perform:
receiving the second question from the user;
determining whether the second question is a topic shift from the first question;
upon determining that the second question is not a topic shift from the first question:
providing the second question and the first set of metadata to the vector database;
receiving, from the vector database, a second set of data chunks;
providing the second set of data chunks and a second context, the second context comprising the second question, to the artificially intelligent language model;
receiving, from the artificially intelligent language model, a second set of metadata and a second response;
storing the second set of metadata for use with a third question; and
providing the second response to the user.
